(19) United States
(12) Patent Application Publication
(10) Pub. No.: US 2008/0067172 A1
(43) Pub. Date: Mar. 20, 2008

(54) Container Closure for a Container Comprising a So-Called "Push-Pull" Closure

(76) Inventor: Rene Wilhelm, Lutisburg Station (CH)

Correspondence Address: WILLIAM COLLARD;COLLARD & ROE, P.C., 1077 NORTHERN BOULEVARD, ROSLYN, NY, 11576, US

(21) Appl. No.: 11/886,349

(22) PCT Filed: Mar. 20, 2006
(86) PCT No.: PCT/CH06/00165

§ 371 Date: Sep. 14, 2007

(30) Foreign Application Priority Data
Mar. 23, 2005 (CH) 496/05

(51) Int. Cl. B65D 17/34; B23P 19/04

(52) U.S. Cl. 220/270; 29/700

(57) ABSTRACT

The invention relates to a “push-pull” type closure (2) for a container comprising a cover part (1) which can be placed about a container opening and which comprises a sealing lip (4), and a sliding part (6) which is applied in a displaceable manner to the cover part (1). An outflow opening (5) can be opened or closed by displacing the sliding part (6) on the cover part (1). A splitable or piercable closure film (77) is applied to the sealing lip (4), whereby an additional chamber (8) which is divided in a sealed manner in relation to the contents of the container, is formed the inner chamber of the cover part (1) which is oriented towards the sliding part (6). A pin (9) is applied in a displaceable manner to the cover part (1) and comprises a tearing and piercing device (10). The closure film (7) can be torn open or pierced when the pin (9) is actuated and a substance or active substance can be added to the additional chamber (8) which can also penetrate into the container. One advantage thereof is that the active substance which is sensitive to surrounding influences can be contained in the closure of the container (2), and that the active substances can be mixed with the contents of the container immediately prior to the use and in a simple manner.

The invention relates to a container closure for a container comprising a so-called “push-pull” closure according to patent claim 1 as well as to a method for producing such a container closure according to patent claim 9.

In the field of sports drinks, but to an increasing extent also in more and more market sectors, there is an intensely increasing demand for being able to offer vitaminized or otherwise enhanced beverages in suitable containers. In addition to beverage products by Vittel, beverages such as “smart water” or “vitamin water” are available in the U.S. as well. Typically, these are beverages based on ordinary drinking water, which are, however, enhanced with additives, such as flavors, dyes, vitamins or the like for the purpose of increasing the attractiveness or functionality. Generally, due to the fact that what is also sold along with such beverages is a “lifestyle”, the containers and bottles used for this are often generally also transparent or at least translucent, so that the color assigned to a special fruit or flavor can be clearly identified as well.

In particular in the field of sports, but specifically in the field of bicycle sport, beverage bottles, which are suitable for a single-handed operation, are often preferred for sports beverage products. Often, these are beverage bottles comprising so-called “push-pull” closures. Not only can such beverage closures be easily opened, but they can also be closed again after being used by means of a simple push of the thumb. Container closures of this type are thus increasingly popular.

EP-1 025 014 describes such a “push-pull” closure for a sports beverage container. This container closure encompasses a cover, which is designed to be attached to a container opening of a container. The cover encompasses a cover opening comprising a tip, which is used for drinking. The tip, which is attached to the cover so as to be capable of being displaced, can thereby be moved back and forth between a closed position, which seals the cover opening, and an open position, which releases the cover opening.

Enhanced beverages as described above are mostly distributed already pre-mixed. As already mentioned, such beverage additives often include vitamins. Individual vitamins, such as vitamin C, for example, have the characteristic that they are relatively quickly destroyed by the effect of heat, UV-radiation or by being combined with oxygen or that their content is highly reduced. Sensitive vitamins should thus advantageously be added only shortly prior to the consumption of the beverage. For the same reason, transparent or translucent beverage containers are often not suitable for the long-term storage of vitamin beverages.

There is thus a demand for being able to offer beverages comprising enhancements by means of vitamins or other physiologically effective substances in beverage bottles, the handling of which is very simple, on the one hand, and which allow for the addition of the sensitive active additives only directly prior to the consumption of the base beverage in a simple and uncomplicated manner. Furthermore, these beverages should also be suitable for being sold on shelves. However, in this regard, popular “push-pull” container closures do not permit a simple handling, because the containers must be unscrewed and the additives must be manually added or bottled.

DE-87 09 336-U1 describes a bottle closure comprising a container for a secondary beverage and a mixing device. In this bottle closure, which, however, is not designed as a drink closure, a liquid A and a liquid B are separated from one another by means of a film. A pin serves the purpose of piercing the film. With this device, the user can achieve a mixing of the liquids A and B by means of a simple pressure onto the upper part of the closure from the top. In this device, the upper part of the closure must then be completely removed so as to be able to remove the beverage. This bottle closure is thus unsuitable for a single-handed operation.

Finally, DE-44 10 323-A1 shows a closure cap for a pharmaceutical product, which is contained in a container, in particular in a so-called injection bottle. This is also not a drink closure. Provision is made here in the closure cap for a receiving space for a second component, which is supplied to the pharmaceutical product contained in the container prior to being used. For this purpose, a separating wall is penetrated by means of a cutting pin, which is connected with the screw cap in one piece. However, with this solution the cover must subsequently be removed in its entirety so as to be able to remove the substance. This container closure is thus also unsuitable for the single-handed operation.

US-2004/011679 shows a container closure comprising a number of additive dispensing means, which can be actuated selectively. In addition to a centrally arranged “push-pull” closure, a plurality of stamps (so-called “plungers”), which can be actuated by means of being depressed, are arranged at the periphery of the “push-pull” closure. By means of actuating one of these plungers, a seal, which is designed as a metal film and which apparently belongs to the container closure, is pierced and an additive arranged in a cavity below the respective plunger is released. The operating elements for the container closure (“push-pull” central closure) and for the additive admixture are thus separated from one another here with regard to their function and configuration. Provision is made for powdery, granulated or solid substances (e.g. pills) as additives. The illustrated solution, however, is unsuitable for liquid additives, because this would lead to unsolved sealing problems for the plungers, due to their simple sliding guides.

The same disclosure also shows an alternative embodiment comprising blister-like chambers instead of plungers. For lack of necessity, the separate piercing elements are, of course, not necessary in this case, because the pills contained in the blister chambers can assume this role themselves. However, this also means that a correspondingly solid blister chamber content is necessary and that liquid contents cannot simply be considered. In addition, the volumes available for blister chambers would already be much too small for additives in popular additive applications, such as, e.g. liquid vitamin concentrates.

Finally, U.S. Pat. No. 6,230,884 shows a container closure comprising a releasable pill chamber. A centrally arranged “push-pull” closure has a tip and a pill chamber, which is arranged below this tip and which is formed from a film. The film of the pill chamber is pierced in response to the actuation (depressing) of the tip, which releases the additive. The first-time depression causes the release of the additive and simultaneously also closes the “push-pull” closure. The operating elements for the container closure (“push-pull” central closure) and for the additive admixture are thus combined with one another here with regard to their function and configuration. Even though this permits a simple construction, it has the disadvantage, at the same time that the volume available for an additive is very small. Furthermore, the pill chamber can be placed on the container opening, in each case as a component, which is not integrated in the container closure, which is separate and which is replaceable.

The object is thus to improve a container comprising a so-called “push-pull” closure of simple construction in such a manner that liquid active substances, which are sensitive to environmental influences, can already be contained in the closure to a sufficient extent and that these active substances can be admixed to the container content directly prior to the consumption in a simple manner. Likewise, a simple method for producing such a container closure is to be specified.

This object is solved according to the features of patent claims 1 and 10.

The solution lies in that, with a generic container closure, which typically encompasses a sealing lip in a cover part for the purpose of sealing on a circularly protruding bar of a container opening, on which sealing lip a closure film is attached, which can be torn open or pierced, which creates an additional chamber in the inner chamber of the cover part and the container closure, respectively, which is tightly separated in relation to the container content. The desired active substance, such as a vitamin concentrate for example, can be stored in this additional chamber. Furthermore, a pin, which comprises a tearing and piercing device and which is also displaceable, is arranged in the cover part, wherein the closure film can be torn open or pierced when the pin is actuated, which permits the substance contained in the additional chamber to penetrate into the container. The pin can thereby be actuated very simply by means of being depressed.

Of course, one of the achieved advantages is the simplicity of the device as claimed in the invention in that the pin (9) is arranged centrally and concentrically to the sliding part (6). This also subsequently manifests itself in that, if applicable, even already produced “push-pull” closures can be refitted, because changes do not need to be made to the basic design of the cover part, with the exception of a pin opening at the front end of the cover part, wherein this pin opening, for the most part, can also be attached afterwards.

Further advantages also lie in that the (intact) closure film creates an improved gas-tight seal, which is advantageous in particular for carbonated beverages, because the “freshness” thereof remains ensured for a longer period of time. Due to the fact that the closure film (7), in its intact state, prevents the container content from flowing through the outflow opening (5), this can certainly also counteract the known shortcomings of the gas-tightness of “push-pull” closures. Due to the fact that, additionally, the additive substances, which are sensitive to environmental influences, such as UV-radiation, remain in the additional chamber of the container closure until they are consumed, containers or drink bottles can simply also be made of a transparent or at least translucent material, such as, e.g., PET. For example, the user of a beverage bottle, which is designed according to the invention, can thus visually judge the beverage and he can also immediately check the result of his action, for example the dissolution of the vitamin additive.

Furthermore, the invention is suitable for storing an additive substance of a liquid as well as of a powdery consistency. In practice, the often used vitamin additives are, for the most part, of a syrupy consistency.

In further advantageous embodiments of the invention, the cover part can additionally be provided with a safety ring (tamper-proof indication). Likewise, the container closure can additionally encompass a safety cap. This safety cap can serve the purpose of preventing contaminations in the area of the outflow and drink opening, respectively, as well as an accidental actuation of the pin. Of course, to avoid the latter, other provisions could also be made, for example sleeve-like parts, which can easily be pushed away.

To improve the gas-tightness of the closure film, it is advantageously designed as a coated metal film, wherein the coating can either be a lacquer or a plastic material. This then also facilitates the tight connection of the metal film with the sealing lip of the cover part, which generally is also made of a plastic material. In these cases, a suitable heat-welding method, such as an induction welding, for example, can be used for connecting the closure film with the sealing lip.

Furthermore, the tearing and piercing device is advantageously provided with a plurality of longish tearing edges, which are substantially arranged in a star-shaped manner. This has the effect that the tearing and piercing effect at the closure film is achieved in a large-surface manner and not only selectively, because, otherwise, only a slow an insufficient mixing could occur, in particular with the use of viscous or powdery additives.

An advantageous embodiment of the invention also lies in that the pin can be connected with the tearing and piercing device by means of being plugged into one another and by means of being engaged with one another, respectively. Of course, this can also be achieved by means of a suitable mechanical design of the parts, which is known to the person of skill in the art.

The preferred method for producing a container closure as claimed in the invention then also consists in that, with a generic “push-pull” closure, the pin is initially inserted from the side of the outflow opening, while the tearing and piercing device is introduced from the other side and the two parts are subsequently plugged into one another and are connected with one another, respectively. The provided substance is then added to the additional chamber and the closure film is subsequently placed onto the sealing lip of the cover part and is connected and welded with the same, respectively, so as to be impermeable to liquids.

As already mentioned, a particular advantage lies in that this production method is generally also suitable for the refitting of “push-pull” closures. Refittings can only be problematic if the contact surface on the sealing lip is not sufficiently large so as to ensure a sealing connection between the closure film and the sealing lip.

In the drawings:

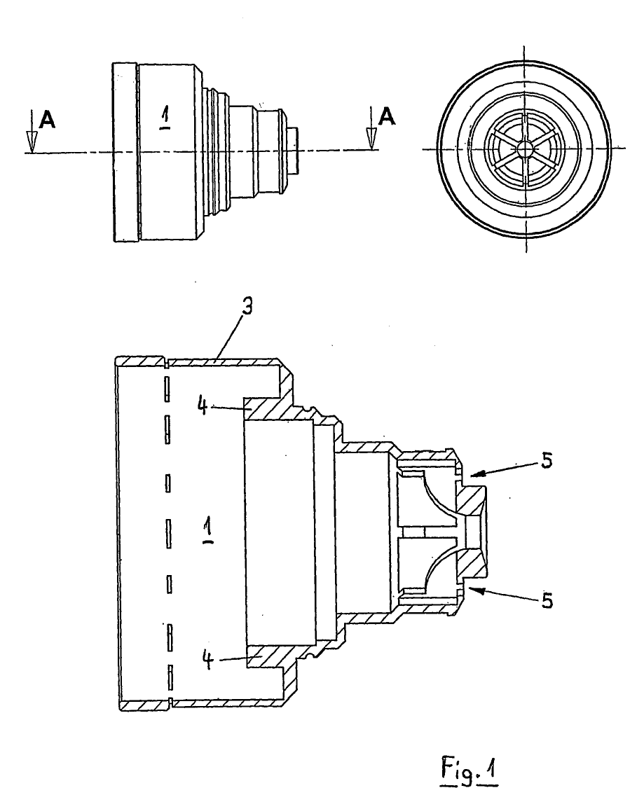

FIG. 1 shows a cover part of a container closure according to the invention in a side view, a top view and a section along line A-A-,

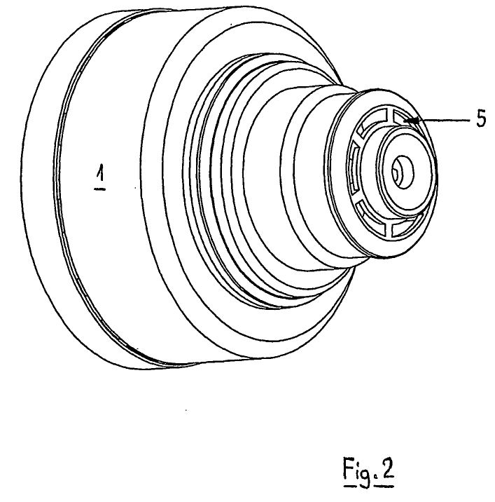

FIG. 2 shows a cover part according to FIG. 1 in a 3-D view,

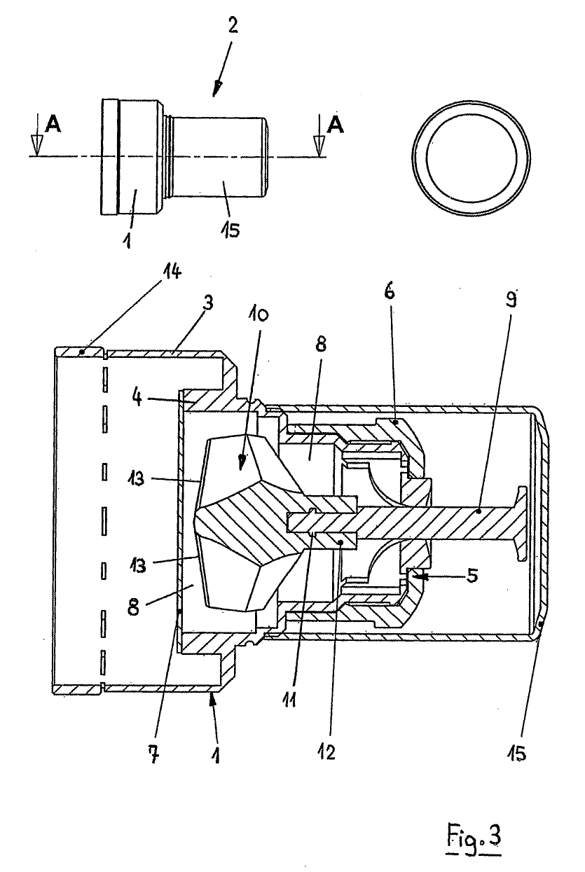

FIG. 3 shows a container closure as claimed in the invention in a side view, a top view and a section along line A-A,

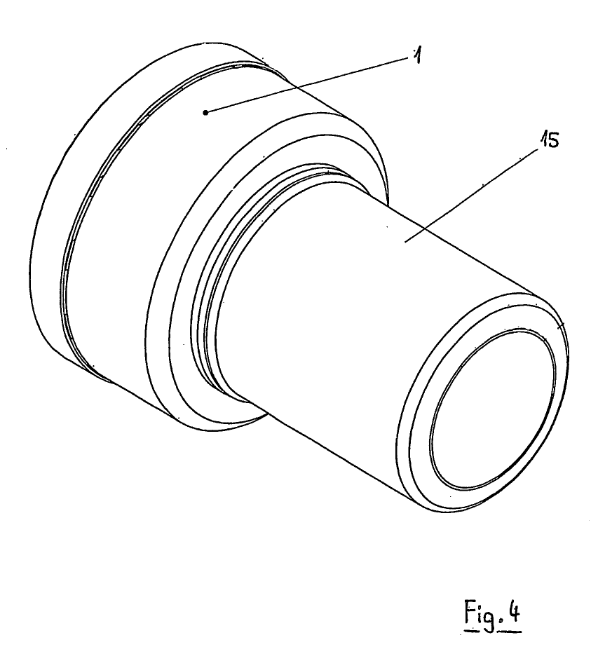

FIG. 4 shows a container closure according to FIG. 3 in a 3-D view and

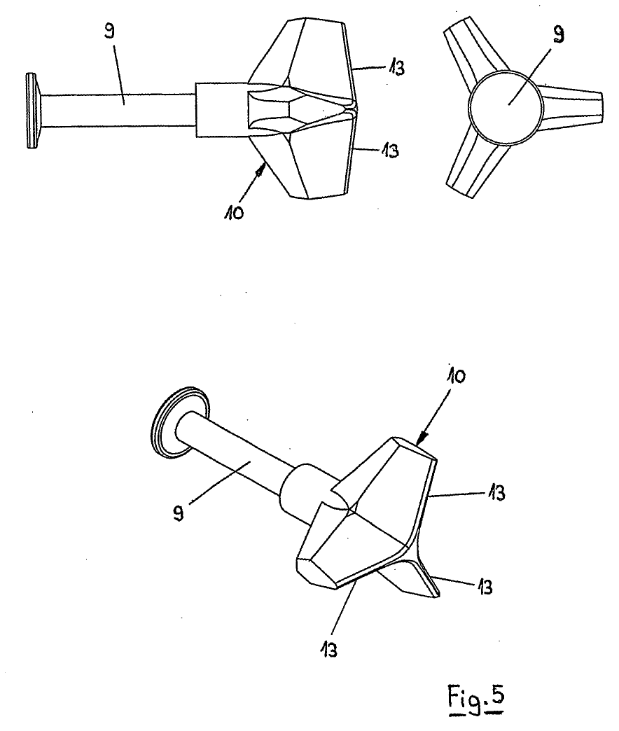

FIG. 5 shows a tearing and piercing device comprising a pin in a side view, a top view and a 3-D illustration.

FIG. 1 shows a cover part 1 of a container closure 2 according to the invention in a side view, a top view and a section along a line A-A. The container closure 2 can thereby be placed about a (non-illustrated) container opening. In the instant case, the container opening encompasses a circularly protruding bar (also not illustrated), wherein this bar extends into an outer wall 3 and a sealing lip 4, which is also arranged on the cover part 1 in a circular manner. A seal between the container and the container closure 2 occurs via the sealing lip 4. Furthermore, the cover part 1 encompasses an outflow opening 5 in a front part.

FIG. 2 shows the cover part 1 according to FIG. 1 in a 3-D view.

FIG. 3 shows a container closure 2 according to the invention in a side view, a top view and a section along line A-A. In the front part of the cover part 1, a sliding part 6 is placed onto the cover part 1 in an axially displaceable manner. The outflow opening 5 can be released or closed by axially displacing the sliding part 6 on the cover part 1. The sliding part 6 is illustrated herein in the position, in which the outflow opening 5 is closed. The sliding part 6 is designed in such a manner that it can be pushed open with one hand or with one or two fingers, in response to an embracing of the container closure 2 and that it can be closed again with at least one finger. This is characterized as the so-called “push-pull” function.

A closure film 7, which can be torn open and/or pierced, is attached to the sealing lip 4. This closure film 7 forms an additional chamber 8 in the inner chamber of the cover part 1, which faces the sliding part, which is tightly separated in relation to the container content. It should be clear that the separated additional chamber 8, which is created in such a manner, is also closed against the outside only if the sliding part 6 closes the outflow opening 5, as is shown in FIG. 3. A substance (not illustrated) can be added to the additional chamber 8.

Furthermore, a pin 9 comprising a tearing and piercing device 10 is also attached in the cover part 1 so as to be capable of being axially displaced. The closure film 7 can be torn open and/or pierced by means of the tearing and piercing device 10. Provided that the closure film 7 is still intact, the tearing and piercing device 10 is thus located in the additional chamber 8. By means of actuation of the pin 9 (pressing against the closure film and tearing the same), a substance, which was added to the additional chamber prior to the application of the closure film 7, can thus penetrate into the container an can mix therein with the container content.

The additional chamber 8 is designed for the storage of a substance of liquid or powdery consistency. Vitamin additives for beverages often have a syrupy, relatively viscous consistency. In particular in the case of vitamin additives, the closure film 7 must ensure a closure of the additional chamber 8, which is liquid-tight and, ideally also as gas-tight as possible. Closures, which are as gas-tight as possible, are desirable in particular in applications with carbonated beverages. The closure film 7 is thus preferably a coated metal film, wherein the coating can either be a lacquer or a plastic material. This then also facilitates the tight connection of the closure film 7 with the sealing lip 4 of the cover part 1, which typically is also made of a plastic material. In these cases, a suitable heat-welding method, such as an induction welding, for example, can be used for connecting the closure film 7 with the sealing lip 4.

The suitability of the container closure according to the invention for the storage of substances of liquid or powdery consistency, in particular also of those substances comprising a high sensitivity to environmental influences, such as the mentioned vitamin additives, is certainly considerably supported with the use of suitable materials. The material, of which the cover part 1 and the sliding part 6 are made up of, should thus be completely non-transparent for UV-radiation, so as to protect the radiation-sensitive components from a premature destruction or change.

Advantageously, the pin 9 and the tearing and piercing device 10 are designed so as to be capable of being connected by being plugged into one another. Of course, the ability to be connected by means of being plugged into one another or by means of being engaged with one another, which is known to the person of skill in the art, can be achieved by means of a mechanical design of the parts. As is illustrated in FIG. 3, the pin 9 can encompass cam-like engagement elements 11, which fit into elastically spreadable receiving parts 12 of the tearing and piercing device 10. Preferably, the tearing and piercing device 10 encompasses a plurality of longish tearing edges 13, so as to achieve a tearing or piercing effect, which is as large-surface as possible. The longish tearing edges 13 have the effect that the tearing and piercing effect at the closure film 7 is achieved in a large-surface and not only selective manner, because, otherwise, only a slow and insufficient mixing could possibly occur, in particular with the use of viscous or powdery additives.

Incidentally, the container closure 2 according to the invention can additionally also encompass further components. A safety ring 14 (tamper-proof ring), which can be torn away, and which indicates whether the container has already been opened, can be attached to the cover part 1. Furthermore, a safety cap 15 can also be present on the cover part 1 and above the sliding part 6 and the pin 9. This safety cap 15 can serve the purpose of preventing contaminations in the region of the outflow opening 5 and drink opening, respectively, as well as an accidental actuation of the pin 9. Of course, to avoid the latter, other provisions could also be made, for example sleeve-like parts, which can easily be removed about the part of the pin 9, which is visible from the outside.

FIG. 4 shows the container closure 2 according to FIG. 3 in a 3-D view.

FIG. 5 shows the tearing and piercing device 10 comprising the pin 9 in a side view, a top view and a 3-D illustration. In particular, it can be seen from the 3-D view that the tearing edges 13 are preferably arranged in a star-shaped manner. In this case, provision is made for three tearing edges 13, but provision can also be made for a different number.

The preferred method for producing a container closure according to the invention lies in that, with a generic “push-pull” closure (that is, with a container closure comprising at least one cover part 1 and a sliding part 6 being located thereon), the pin 9 is initially inserted from the side of the outflow opening 5, while the tearing and piercing device 10 is introduced from the other side and the two parts (9, 10) are subsequently plugged into one another and are connected with one another, respectively. Upon making sure that the sliding part 6 closes the outflow opening 5, the provided substance is added to the additional chamber 8 and the closure film 7 is subsequently placed upon the sealing lip 4 of the cover part 1 and is connected and welded, respectively, with said sealing lip 4 of the cover part 1 so as to be impermeable to liquids. The container closure 2 is then ready to be attached to a container.

During use, for example, the user of a drink bottle, which is equipped with a container closure as claimed in the invention, will initially remove the safety cap 15. In order to mix the vitamin additive in the additional chamber 8 with the content of the drinking bottle, the pin 9 is pressed firmly downwards. The tearing and piercing device 10 thus pierces and tears the closure film 7 and the liquid vitamin additive can flow out of the additional chamber 8 into the container. When using a transparent drinking bottle, the user can thus generally directly check the result of his action. In order to drink from the drinking bottle, the user must only press open (or pull open) the sliding part 6 so as to open the outflow opening 5. Subsequently, the drinking bottle can then again be closed tightly by means of the sliding part 6. After its actuation, the pin 9 can, of course, remain in the depressed position. The drinking processes are thus in no way hindered, because the end of the pin can be constructively designed in such a manner that, when depressed, only an elevation, which is barely noticeable and which also does not interfere, forms in the center region.

### LIST OF REFERENCE NUMERALS

1 cover part
2 container closure
3 outer wall
4 sealing lip
5 outflow opening
6 sliding part
7 closure film
8 additional chamber
9 pin
10 tearing ad piercing device
11 engagement element
12 receiving parts
13 tearing edge
14 safety ring
15 safety cap

1. A container closure (2) for a container comprising a so-called “push-pull” closure, wherein the container closure (2) encompasses a cover part (1), which can be placed about a container opening and which comprises a sealing lip (4) and a sliding part (6), which can be attached to the cover part (1) so as to be capable of being displaced such that an outflow opening (5) can be opened or closed by displacing the sliding part (6) on the cover part (1), wherein
a closure film (7), which can be torn open or pierced is attached to the sealing lip (4), whereby an additional chamber (8), which is separated in a sealed manner in relation to the container content, is formed in the inner chamber of the cover part (1), which is oriented towards the sliding part (6) and
that a pin (9) comprising a tearing and piercing device (10) is also arranged in the cover part (1) so as to be capable of being displaced, wherein the closure film (7) can be torn open or split when the pin (9) is actuated and a substance, which can be added to the additional chamber (8), can thus penetrate into the container,
wherein the additional chamber (8) of the container closure is designed so as to be tight for the storage of a substance being made up of a liquid or powdery consistency.

2. The container closure (2) according to patent claim 1, wherein the additional chamber (8) of the container is designed so as to be radiation-protected for the storage of a UV-radiation-sensitive substance.

3. The container closure (2) according to patent claim 1, wherein the pin (9) is arranged centrally and concentrically to the sliding part (6).

4. The container closure (2) according to patent claim 1, wherein, when intact, the closure film (7) prevents an outflow of the container content through the outflow opening (5) by means of covering the entire container opening cross section.

5. The container closure (2) according to latent claim 1, wherein the cover part (1) additionally encompasses a safety ring (14).

6. The container closure (2) according to patent claim 1, wherein the container closure (2) additionally encompasses a safety cap (15).

7. The container closure (2) according to patent claim 1, wherein the closure film (7) is a coated metal film.

8. The container closure (2) according to patent claim 1, the pin (9) can be connected with the tearing and piercing device (10) by means of being plugged into one another.

9. The container closure (2) according to patent claim 1, the tearing and piercing device (10) has a plurality of longish tearing edges (13) so as to achieve a large-surface tearing and piercing effect with it.

10. A method for producing a container closure (2) according to patent claim 1, comprising the following method steps:
providing a container closure for a container comprising a so-called “push-pull” closure, wherein the container closure encompasses a cover part (1), which can be placed about a container opening and which comprises a sealing lip (4) and a sliding part (6), which can be attached to the cover part (1) so as to be capable of being displaced such that an outflow opening (5) can be opened or closed by displacing the sliding part (6) on the cover part (1),
inserting a pin (9) into the cover part (1),
inserting a tearing and piercing device (10) into the cover part (1) from the opposite side and connecting the pin (9) with the tearing and piercing device (10),
checking that the sliding part (6) closes the outflow opening (5),
filling a substance into the additional chamber (8) and
inserting a closure film (7) on the sealing lip (4) of the cover part (1) and subsequently connecting the closure film (7) with the sealing lip (4) by means of a suitable connecting method so as to be impermeable to liquids.
